(19) United States
(12) Patent Application Publication
(10) Pub. No.: US 2014/0026178 A1
(43) Pub. Date: Jan. 23, 2014

(54) Video processing system providing interactivity independent of service provider equipment and video output device

(71) Applicants: John Lynch, Campbell, CA (US); Michael Ure, Cupertino, CA (US)

(72) Inventors: John Lynch, Campbell, CA (US); Michael Ure, Cupertino, CA (US)

(21) Appl. No.: 14/032,364

(22) Filed: Sep. 20, 2013

Related U.S. Application Data
(63) Continuation of application No. 13/089,526, filed on Apr. 19, 2011, now abandoned.

(51) Int. Cl. H04N 21/41

(52) U.S. Cl. CPC H04N 21/4126
USPC 725/133

(57) ABSTRACT

Described herein is a video display arrangement in which a video signal from a video source is intercepted and, in response to a command from a user, a desired video signal is obtained by at least one of substituting a different video signal for the video signal from the video source and augmenting the video signal from the video source to add interactivity information for display to the user. The desired video signal is applied to a display device and displayed to the user. The arrangement may use a smart cable or a small accessory.

### RELATED APPLICATIONS

Priority is claimed of U.S. Application Ser. No. 61/325,565 filed Apr. 19, 2010, incorporated herein by reference.

### BACKGROUND

1. Field of the Invention

The present invention relates to interactive video systems.

2. State of the Art

Interactivity for television viewing has long been proposed. The Time Warner Full Service Network (FSN) operated on a trial basis in Orlando, Fla. during the years 1995-1997 featured certain voice-interactive features. Nevertheless, interactivity for television viewing has not achieved widespread adoption. Both service providers and device makers have, in general, been slow to embrace innovation in this respect. There remains a need for TV interactivity, e.g., voice interactivity, and especially for arrangements that side step both service providers and devices makers to provide the same.

Described herein is a video display arrangement in which a video signal from a video source is intercepted and, in response to a command from a user, a desired video signal is obtained by at least one of substituting a different video signal for the video signal from the video source and augmenting the video signal from the video source to add interactivity information for display to the user. The desired video signal is applied to a display device and displayed to the user. The arrangement may use a smart cable or a small accessory.

### BRIEF DESCRIPTION OF THE DRAWING

The present invention may be understood from the following detailed description in conjunction with the appended drawing figures. In the drawing:

FIG. 1 is a block diagram of a video display system.

FIG. 2 is a diagram of a cable arrangement that may be used in the system of FIG. 1.

FIG. 3 is a block diagram of another video display system.

FIG. 4 is a block diagram of electronics that may be used in the video display systems of the preceding figures.

FIG. 5 is a diagram of a reverse side of a remote control unit.

### DETAILED DESCRIPTION

It will be appreciated by those of ordinary skill in the art that the present invention may be embodied in other specific forms than those described below without departing from the spirit or essential character thereof. The following description is therefore intended in all respects to be illustrative and not restrictive. The scope of the invention is indicated by the appended claims, not the following description, and all changes which come within the scope and range of equivalents thereof are intended to be embraced therein.

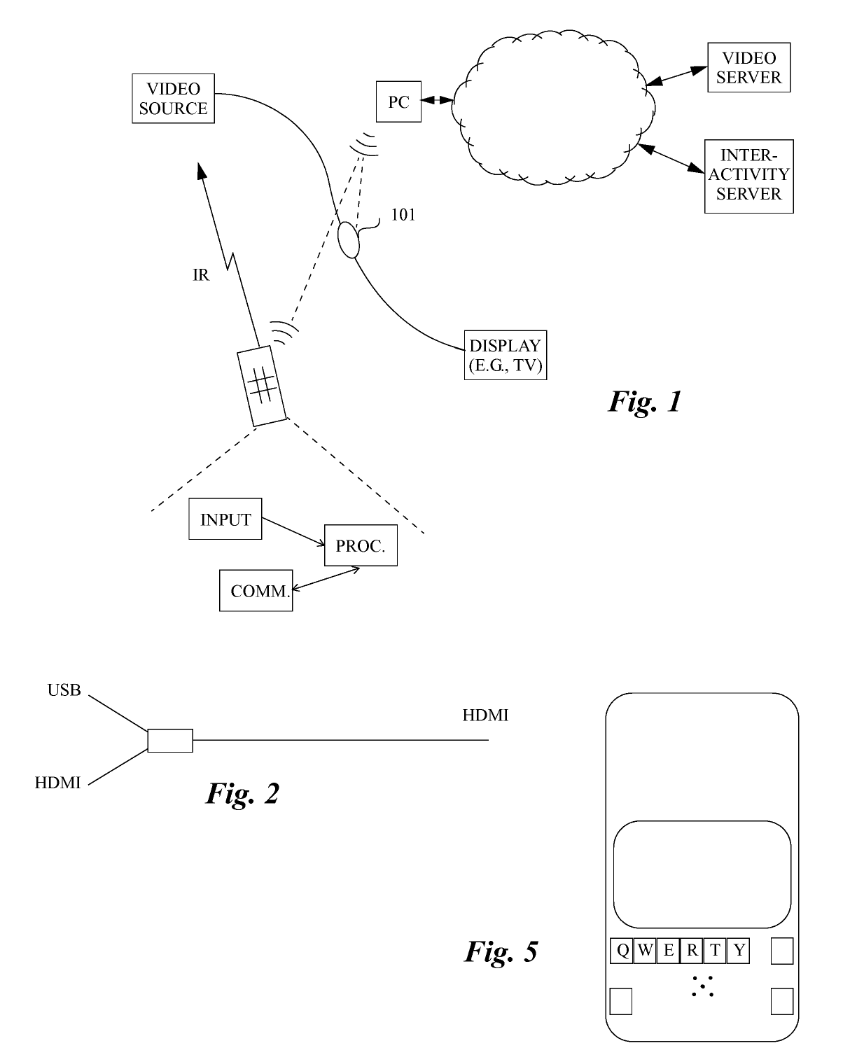

Referring to FIG. 1, a diagram is shown of a video modification system. A video source such as a set-top box (STB) is coupled through a cable to a display such as a TV. The cable is attached to an enclosure 101 provided with electronics that in some instances modifies a video signal from the video source by adding interactivity information for display to a user to produce an augmented video signal. The interactivity information may be displayed in various ways including, for example, a video overlay, or in a region surrounding a video display region. If needed, the video signal from the video source may be scaled to allow for such framing. In other instances, the video signal from the video source may be passed along unchanged to the display. The cable is referred to herein as a smart cable. The cable may be any of various types including, for example, HDMI, HDbaseT, etc.

Interactivity information may be obtained, for example, via a PC or the like, connected to the internet, an intranet, or some other network, the network having connected to it an interactivity server. The interactivity information may support any of various types of user activity using, for example, voice, gestures, touch, keystrokes or button presses, point-and-click, etc. One exemplary application is a voice-driven electronic program guide (EPG) application. Using a voice-enabled remote control, the user tells the remote control what he or she wants to watch and the system finds the desired program. Users can find favorite programs and channels by name, search programs by title, actor or sports team, scan various categories of programming, etc.

Various other kinds of interactivity may be provided, one example of which is described in U.S. application Ser. No. 12/688,975 titled System and Method for Interaction With a Media Device User Such as a Television Viewer filed Jan. 18, 2010 under the name of Michael J. Ure.

The interactivity information retrieved by the PC may, in one embodiment, be transmitted wirelessly to the smart cable electronics, which may include a wireless receiver or transceiver of any of various types, e.g., WiFi™, Bluetooth™, Zigbee™, UWB, WirelessHD (60 GHz), etc. The PC may also transmit control information to the smart cable electronics.

In one embodiment, user interaction occurs using a remote control device. In this embodiment, the remote control is voice-enabled and transmits voice information captured from a user utterance to the PC and then to the interactivity server, which may then perform speech recognition and take steps to perform appropriate action based on the recognition results. One such action might be to display a grid of available programs matching certain criteria expressed in the utterance. The remote control may be provided with a wireless receiver or transceiver of any of various types, e.g., WiFi™, Bluetooth™, Zigbee™, UWB, WirelessHD (60 GHz), etc. In one embodiment, the remote control is provided with bi-directional RF (radio frequency) connectivity and uni-directional IR (infrared) connectivity, the latter for transmitting commands to the video source. The remote control may configured to enable a unified interface with multiple devices. Considering the voice-driven EPG application, for example, when EPG information is displayed, the remote is set to a mode such that button presses such as up/down, select, etc. are communicated only to the PC or the interactivity server (no IR output). Once a selection has been made, the PC or the interactivity server tells the remote control what the selection means for purposes of the video source and causes the remote to make the appropriate IR output to the STB. In this manner, the remote control serves as a relay/translator between the PC or interactivity server and the video source.

Optionally, the remote control may also include a vibrator that may be used to prompt the user to respond to interactivity information.

Referring to FIG. 5, in some embodiments, a reverse side the remote control may be provided with a QWERTY keypad and/or a touchpad. The touchpad may be single-touch or multi-touch. The front side of the remote control may be provided with a layout of buttons (volume, channel, etc.) so as to provide the user a familiar experience.

In some instances, the PC may be connected through the network to a video server. Video content and video programs are available from various sources such as YouTube™, media outlets and the like. Based on user actions communicated via the remote control, the PC may retrieve video content from the video server and control the smart cable electronics such that the video content is substituted in place of the video signal from the video source. The smart cable electronics in this instance behave as a switch or program selector or mux.

In other instances, the smart cable electronics may be controlled so as to display static (non-video) display information in lieu of the video signal from the video source. For example, in a voice-driven EPG application, a program grid, instead of being overlaid on top of video of the video signal from the video source, may replace the video entirely until a selection has been made. Hence, the smart cable electronics may perform operations including, in order of increasing complexity, switching to a static display, video overlay, video scaling and framing, and switching to different video.

The smart cable electronics may be powered from the cable or from an auxiliary power source such as a wall adapter, a USB connection, etc. In FIG. 2, the smart cable electronics are shown as being powered by a USB connection.

The enclosure may be molded as part of the cable itself. Alternatively, the enclosure may be small housing provided with cable connectors. If desired, shrink tubing may be used to attached cables to the housing in a semi-permanent manner, minimizing setup to be performed by the user and minimizing possible confusion. A simple plug-in connection is not “semi-permanent” as that term is used herein.

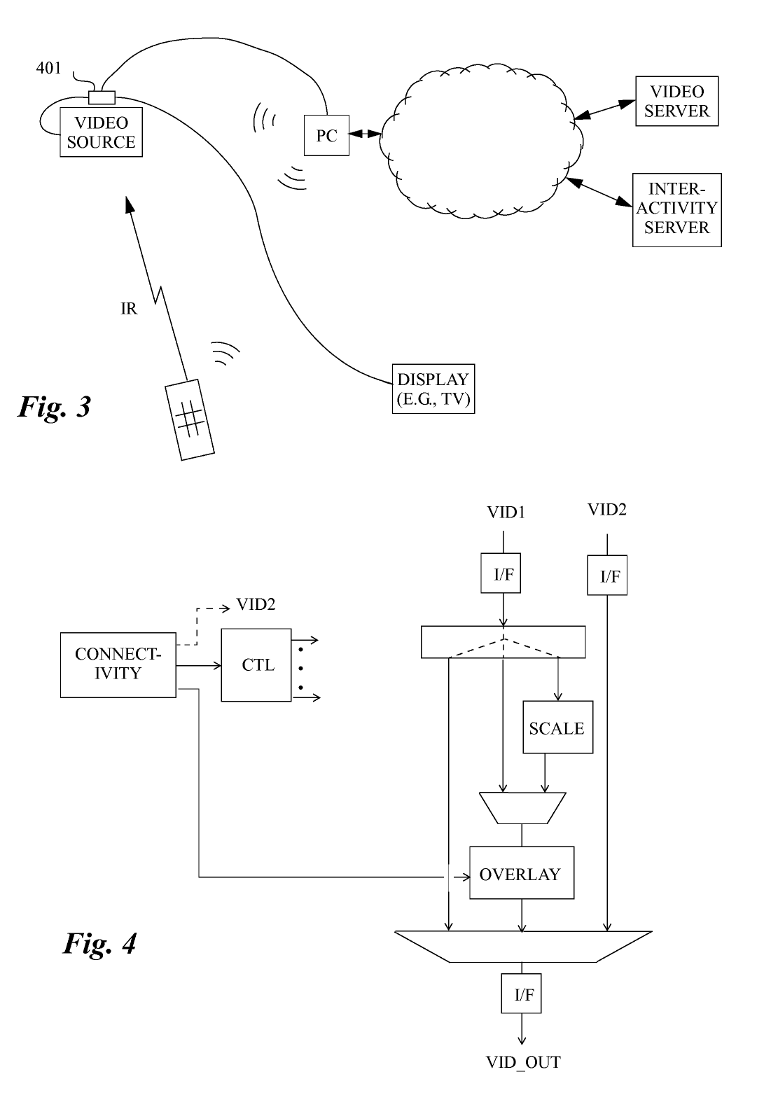

Referring to FIG. 3, in another embodiment, electronics like the smart cable electronics of FIG. 1 may be housed within a housing 301 that may be situated near (e.g., on top of) the video source. Instead of being connected by two wired connections and a wireless connection as in FIG. 1, the electronics may be connected by three wired connections such as HDMI, HDbaseT, etc. In the connections are HDbaseT, then power may also be provided via the same connections. Operation of the system of FIG. 3 may be similar to that of FIG. 1.

In still another embodiment, the enclosure of FIG. 1 may be arranged to receive, in addition to the inputs previously described, a further HDbaseT input. Operation of this embodiment is similar to that of the embodiment of FIG. 3.

Referring to FIG. 4, a diagram is shown of one exemplary embodiment of electronics that may be used in the systems of FIG. 1 and FIG. 3. A video signal VID1 from the video source is split into three signal paths. A first signal path is applied directly to an output multiplexer (“mux”). A second signal path is applied to a selection mux. A third signal path is applied first to a scaler and then to the selection mux. An output signal of the selection mux is applied to an overlay unit, an output of which is applied to the output mux. A video signal VID2 is applied directly to the output mux, which selects one of its inputs as the output signal VID_OUT. A control unit applies control signals to the various other blocks based on signal received from a connectivity unit. The connectivity unit receives interactivity information and supplies that interactivity information to the overlay unit. Optionally, the connectivity unit may also receive the video signal VID2.

The video signal from the video source may be protected using HDCP or some other content protection mechanism. In order to alter the video content, a license is typically required. Under license, this protection may undone; then, after the video content has been altered, the protection may be reapplied.

In the foregoing manner, interactivity, e.g., voice interactivity, may be provided independently of service provider equipment and video output devices. A unified interface may be provided that allows for control of both interactivity and the service provider equipment in a seamless fashion. The result is greater ease of use and a richer, more engaging, and more satisfying media experience.

The scope of the invention is indicated by the appended claims, not the following description, and all changes which come within the scope and range of equivalents thereof are intended to be embraced therein.

What is claimed is:

1. A handheld device comprising a controller, a WiFi transceiver, an HDMI port and a male HDMI connector coupled to the HDMI port, wherein the handheld device receives video content over a WiFi connection and outputs the video content to a display device via the HDMI port.
